(19) United States
(12) Patent Application Publication
(10) Pub. No.: US 2011/0010303 A1
(43) Pub. Date: Jan. 13, 2011

(54) REALTY BUSINESS METHOD

(75) Inventor: Mark Palmero L'Boe, St. Louis, MO (US)

Correspondence Address: Polster, Lieder, Woodruff & Lucchesi, L.C., 12412 Powerscourt Dr. Suite 200, St. Louis, MO, 63131-3615, US

(73) Assignee: 321-SOLD-AHG LLC, St. Louis, MO (US)

(21) Appl. No.: 12/833,686

(22) Filed: Jul. 9, 2010

Related U.S. Application Data
(60) Provisional application No. 61/224,700, filed on Jul. 10, 2009.

(51) Int. Cl. G06Q 50/00; G06Q 30/00

(52) U.S. Cl. 705/316; 705/313

(57) ABSTRACT

A four-step real estate selling method or process. In the first step, a Zone Rep, who is a licensed real estate agent, meets with a seller and prepares the information necessary for a real estate listing. In the second step, a Marketing Manager develops a customized marketing plan with the owner. The plan includes all customary real estate marketing tools and a few proprietary methods. In the third step, calls or e-mails to a call center (Buyer Central) are handled by licensed search and scheduling experts who answer questions and set up property tours for buyers. All property tours are referred to and handled by a network of traditional buyer's agents (Buyer Showing Team), earning the Applicant a referral fee. Buyer Showing Team agents, provide a 30-minute showing service to Buyers originating from Buyer Central. In the fourth and final step, a Designated Broker handles presentation and negotiation of all offers and handles all the closing paperwork details including escrows, inspections, etc.

### CROSS REFERENCE TO RELATED APPLICATIONS

Provisional patent application 61/224,700 filed Jul. 10, 2009

### STATEMENT REGARDING FEDERALLY SPONSORED RESEARCH OR DEVELOPMENT

N/A

### BACKGROUND OF THE INVENTION

The applicant has invented a better business model for residential real estate sales that delivers more service to consumers, reduces commissions and fees to homesellers, pays its workers more, and boasts a 300% greater profitability than an ordinary real estate brokerage business.

The standard business model for the real estate and brokerage industry is grossly inefficient and inconsistent in the delivery of services and results to both homesellers and homebuyers. The industry suffers a low success rate of homes listed to homes sold. This low success rate magnifies the inherent inefficiencies and forces real estate agents and brokerage firms to charge excessively high commissions to compensate for lengthy marketing times and the high marketing costs of homes that go unsold.

In most market areas across the U.S. and during “normal” times, for every 100 homes listed for sale:
30 home sellers will receive an offer from a buyer during the initial listing period (3 to 6 months),
70 sellers will extend the listing period and/or relist with a different real estate firm,
Many sellers, disappointedly, will decide to cancel their move and take their homes off the market.

The industry uses a term known as DOM, or “Days on Market” to measure the length of time a home takes to sell. Given many homes are listed more than once before a sale occurs, another industry term is CDOM, or “Cumulative Days on Market.”

The 10-year average CDOM is estimated at 150+ days in most market areas—an unnecessarily high number that includes home sales during real estate boom times before the 2007 downturn. These numbers provide insights to the fact that industry homeselling practices are inadequate.

An important note about the CDOM is that because only homes that actually sell and close are computed in the “Average CDOM”—that number would rise substantially if the roughly 20% of homes that never sell were to be factored into the “stats.” (Homes that never sell, run for at least one full listing period, and sometimes two or three “re-lists” before ultimately being removed from the market and the statistical tabulations.

The residential real estate brokerage industry suffers from five (5) root problems:
1) Too broadly defined areas of responsibility for agents.
2) Lack of an effective “Home Marketing System” that utilizes systematized methods and procedures.
3) Too many agents, doing too little business.
4) Inadequate buyer capture and conversion systems.
5) Lack of an effective home pricing system.

With respect to the first problem, it is succinctly summarized by the old adage: “Jack of all trades, master of none”. The industry practice has and remains an individual effort by a single person who must possess a myriad of talents in order to be successful. It can take years of experience to gain these skills, yet the average agent stays less than 5 years.

Exhibit A to this Specification identifies the skills an agent must master to succeed in real estate, skills in which most average agents workers never gain proficiency.

As described hereinafter, Applicant's method applies the principles of Fordism, Taylorism, and Post-Fordism to the real estate sales process; that is, agents have a more narrow job description which allows for a faster learning curve, and through consistent practice of a smaller operations set allows them to master their area of expertise more quickly. This is as shown in Exhibit B.

A recent and popular development in the real estate field is the “team” concept where groups of agents come together and operate as a single entity. Interestingly, most teams are husband and wife “duos.” Some will claim that this team approach eases the pressure on a single agent to be available to clients seven (7) days a week. In practice, this works only moderately well for reasons explained in Exhibit C.

Teams are largely formed for monetary reasons and not for greater efficiency or better service to the consumer. This is because team members will pool together their production numbers. This aggregated production creates “buying power” and enables a team of agents to negotiate higher commission splits with their brokerage company. Collectively they earn more money, although overall production remains unchanged. This lost revenue to the brokerage company, provides less incentive for brokerages to provide agents with tools, training, cost-saving services, quality control, and supervision. Ironically, as brokerage overhead is rising, income is falling, and profits are tumbling. Described hereinafter, and shown in Exhibit D, is how Applicant's method differs from the typical Jack-of-all-trades or team approach.

With respect to the second problem noted above, in the traditional business model—a single individual agent is responsible for the entire homeselling process. The single agent model, which is how the majority of transactions are completed, is a “Jack-of-all-trades” approach and works only marginally well for experienced agents. Poor sales production provides clues to this problem. For example, dues-paying members of the National Association of Realtors perform within these production ranges:
The bottom 50% of all agents sell and close 2 or fewer home sales per year.
80% of all agents sell fewer than 4 homes per year.
The top 20% (80^{th} percentile) average as a group, less than 8 homes sales per year.

Further, brokerage firms do not provide a defined “Home Marketing System”, although some franchise brands attempt to use their brand image as a “home marketing system” when in fact there is none. Companies disguise this missing link by touting “personalized service.” However, personalized service really means “anything goes”.

Lacking a home marketing system from their company, enterprising agents often develop their own. But this is usually limited to a checklist of common advertising methods they talk about but don't consistently deliver, if at all. In the pursuit of listings, clever marketers often promote and utilize unproven, ineffective marketing tools and techniques merely as a marketing gimmick to differentiate themselves from other agents.

Part of this lack of effort by brokerage owners to provide systems and procedures is driven by a historically lackadaisical attitude by broker-owners who have long maintained an “If-it-ain't-broke-don't-fix-it” mentality. That and with eroding profit margins, they have little wherewithal or incentive to invent solutions.

As further shown in Exhibit E, over 183 action steps are typical in a standard real estate sales transaction when a seller hires a real estate agent. For ease of understanding, the Applicant has assigned the 183 action steps to the four (4) basic workstation categories. When agents have limited scope of duties, they become more skilled in their respective area of responsibility. From a review of this list, it is clear that most agents lack experience to handle all aspects of the home selling process. And, unfortunately too many agents enter the field.

In most states, a classroom or self-study online course of between 40 and 135 hours (depending on state) is the only prerequisite for obtaining a real estate license. Literally, with as little as one-week of preparation, a person with no background in sales, marketing, negotiation, appraisals, etc. can get a real estate license and join a brokerage firm and become a “Home Marketing Specialist”.

Within two weeks, these new agents begin marketing their services to consumers for substantial commissions. According to the U.S. Department of Justice, which tracks median commissions paid by consumers, in 2007 consumers paid $11,302 to list and sell a home. Industry figures tell us the average full-time agent handles 4.3 home sales per year and the majority of full-time agents have been in the industry for five (5) years or less.

The bottom line is that inexperienced agents with no formal system, skill, or defined area of specialization are handling the typical home sale and charge an excessive fee that compensates for their inefficiency and low success rate.

As described herein, Applicant's solution to this third problem is to i) reduce staff, ii) improve per-person production, iii) lower real estate commissions by up to 40%, and iv) preserve profitability. The fact is that most agents forget from one transaction to the next the tasks that must take place. They forget how to fill out standard contract forms. They miss or delay important marketing steps or deadlines. Mistakes and omissions happen with regularity. Mistakes, that cost time, which is money, to correct. No doubt, mistakes and inefficiencies are factored into the commissions charged to the consumer.

Applicant has invented a systematized approach to the real estate listing, marketing, and selling of residential real estate. This systematized approach streamlines processes and procedures, narrows job descriptions, increases quality control measures, and lowers the cost to consumers by 40%. Interestingly, while charging less to the consumer, profitability is increased through the use of Fordism principles that allow a smaller, but more highly paid workforce to sell more homes in less time.

With regard to inadequate buyer-capture and conversion, It takes listings to attract buyers, but it takes buyers to complete the sale. Buyers inquire about properties seven days a week from 9 am until 9 pm. In fact, brokers spend substantial sums to make the phones ring with potential buyers; but unfortunately, what happens next is one of the weakest links in the process of selling a home. Want proof? Try calling the number on the sign or an advertisement of any real estate company to ask a few questions, or book an appoint to see a house. Even during peak business hours you'll typically get a voicemail message or a receptionist asking the caller to “Leave your name and number and the listing agent will get back to you” type of response.

As described herein, Applicant's solution is to establish an inbound call center, referred to as “Buyer Central” which is manned by licensed search and scheduling experts. An introductory brochure to Buyer Central is shown in Exhibit E. Buyer Central provides immediate responses to buyer inquiries by phone and email seven days a week. Trained search and schedule specialists are on duty daily from 9 am to 9 pm by phone, email, text or fax. Since most buyers are curious about more than just one home, these experts are prepared to provide on the spot information about any home for sale in the area, not just the subject property being called about. Buyer Central also dispatches agents to show homes to interested buyers during daylight showing hours and in selected areas, and offers, for example, a 30-minute express showing service—“See-It-In-30”. An example of a brochure for this service is shown in Exhibit F.

As regards to lack of an effective home pricing system, after “inadequate market exposure”, the number 1 reason homes fail to sell within a reasonable marketing window of 30 to 45 days is price. Given that most agents lack the experience to provide a meaningful opinion—the industry has produced a myriad of computer-generated or computer-assisted pricing mechanisms, all of which attempt to emulate the appraisal process by focusing in on documented sales of like properties. The problem remains that the listing agent is not qualified to interpret the market data properly. They can't, but most try.

However, the public has disdained real estate advice in largely two contrasting planes of thought. The seller has their ‘number’ for the price of the home, and if the agent offers a lower number, the seller believes they are giving the property away. If the agent offers a higher number, the seller is very willing to sign a listing that won't sell (it is overpriced).

The end result is that most sellers hire the agent who overprices the property, has no concept of proper price points, and has no strategic plan to systematically move the seller toward a number that will cause the home to sell within a reasonable time period. This alone explains the dismal performance record of the industry.

Applicant's solution to this fifth problem is a home pricing method, referred to as “Magic Price Points” that works in any market and can be used by anyone. A chart of Magic Price Points is presented in Exhibit G. The Exhibit is a graphic illustration of how novice agents and their sellers can develop a pricing strategy that gets the home sold.

Magic Price Points have little to do with the appraisal value of a home, instead they represent groups of buyers who can afford a certain price range. Rather than relying on non-expert valuation opinions from agents, the Magic Price Points pricing method provides a simple range for a given neighborhood. The seller picks a price point, usually at the high end of the range, and is educated by the agent that if good things don't happen within a few weeks, simply move on to the next lower price point. The “Magic Number” is the price that causes traffic to come through the door, and ultimately causes offers to come in. Use of the Magic Price Points method means that anyone, regardless of experience, can get within the proper range with only one or two price adjustments that are clearly defined in advance.

### BRIEF SUMMARY OF THE INVENTION

The present invention is directed to a method for selling a home involves a system, including a pool of specialists and managers. This workforce is not only available during defined hours (which include evenings, weekends and some holidays), but some are cross-trained in “routine” activities, while others have experience and training to handle “emergencies” which may arise during the selling process.

After an appointment with a potential seller has been set, a Zone Representative (Zone Rep) who works a defined geographical area, meets with the seller and presents the program. Zone Reps are trained in making an effective presentation, as it is their primary job function.

Once the seller agrees to a listing, the Zone Rep follows a checklist to quickly and accurately enter pertinent information, photographs, and documentation into a workflow system. The resulting organized file is forwarded, “upstream”, to the Zone Rep's upline Marketing Manager and the Zone Rep moves on to the next seller.

The Zone Rep's role ends after the initial data entry and paperwork. From there, responsibility for the listing moves to specialists involved at each phase of the process. This narrow job focus permits faster mastery of the Zone Rep's responsibilities and frees his time for greater “through-put” of appointments and listings.

Even while the Zone Rep is completing his duties, the Marketing Manager is in contact with the homeowner to confirm and double-check the marketing information provided by the Zone Rep, and to discuss any “customized” marketing efforts that will be necessary for selling this particular home. The Marketing Manager ushers the listing through the predefined home selling system as expeditiously as possible.

Once basic input is complete, the home's listing information is electronically propagated to dozens of major real estate search engines, which power literally hundreds of local and proprietary websites for maximum online exposure to potential buyers.

From here, the home marketing process moves through stages and various specialists before culminating in sale and closing.

### BRIEF DESCRIPTION OF THE EXHIBITS

The objects of the invention are achieved as set forth in the illustrative embodiments shown in the exhibits which form a part of the specification.

Exhibit A is a list of skills a real estate agent needs to succeed in the real estate business;

Exhibit B is a list of the 4 key roles a real estate agent plays;

Exhibit C compares individual compared to team compared to the real estate selling method of the present invention;

Exhibit D provides an overview of the real estate selling method of the present invention;

Exhibit E is a brochure representing features of a “Buyer Central” portion of the method of the present invention;

Exhibit F is i a brochure representing a “See-it-in-30” feature of the method of the present invention;

Exhibit G is a graph illustrating how price points should be set to assist in pricing a home for sale; and.

Exhibit H is an example of a brochure of Applicant's EvaluRank™ Network used to assist a seller in obtaining a traditional real estate broker.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

The present invention is directed to a method of selling residential real estate and providing associated brokerage services. As described hereinabove, there are a number of problems associated with the way in which residential properties are currently listed for sale and sold. Applicant's method, as described herein, addresses five (5) problems in the traditional real estate sales and brokerage business. These problems are resolved by utilizing the variety of proprietary solutions, systems and processes which are described and which streamline and improve the residential home selling process.

While not everything happens in real estate in a linear fashion, the following illustrates, in a step-by-step sequence of activities, the method or process that comprises Applicant's invention.

### Step 1: Listing Specialist (Zone Rep)

Zone Reps are the first participant in Applicant's process. They are licensed real estate agents and their scope of involvement is limited to:
Lead development, finding potential home selling or home buyer prospects,
Listing presentations,
Helping the seller establish a pricing strategy by using a home pricing system (Magic Price Points™)
Handling of the paperwork, photography, and initial data entry of new listings into a database.

Zone Reps specialize in specific geographic areas in the interest of becoming the “market expert” within their defined area. Zone Reps prospect for clients using a variety of methods for which they are extensively trained. They specialize in building relationships with not only direct prospects, but also second-generation lead building—that is, someone who knows someone with a housing need as a buyer or seller.

Lead development methods include:

For sale by owner campaign

Expired listing campaign

Canvassing neighborhoods

Knocking on doors

Leaving literature & newsletters

Telephone calls

Email campaigns

Social media campaigns

Attend networking functions

Commercial business canvassing

Other

What is important is that the Zone Rep's responsibility in the Applicant's home selling process ends with their placement of a yard sign and lockbox at the listed property. From there, they turn in the file for that property to their “upline” Marketing Manager and return to their daily effort which is, simply put: Find and list another home. The advantage of the Zone rep in Applicant's method is that their narrow job scope keeps Zone Reps focused on what they do best—Prospect, Present, Price, and repeat.

The home pricing system used as part of Applicant's process does not rely on the traditional appraisal of a home. Rather, in using the home pricing system, the seller selects a price or “price point” that matches a value that would be at the top or bottom of a typical purchaser's search range; i.e., the price the purchaser is looking to pay for a house. As described in Exhibit G, a buyer may search between $150,000 and $175,000, or between $175,000 and $200,000. That is, some buyers will want to stay under $175,000, while other buyers will be looking for houses that sell for $175,000 and up. In using the system, price points are not rounded down. That is, $175,000 is not rounded down to $174,900. The use of even thousand dollar price points causes the price ($175,000) to overlap into two categories so that the home may be seen by two sets of potential purchasers rather than just one set. Since most buyers shop for homes online, a house whose price is set at $175,000, for example, will be found by a greater number of people who search online, whether they are searching for a home “up to” $175,000 or from $175,000 “and up”.

### Step 2: Marketing Manager

The Marketing Manager is senior to the Zone Rep in job title and experience in real estate sales. This is in contrast to the ordinary teams where the senior person on the team, the Team Leader, the person with the skill and personality to put the best face on the team before handing it “downline” to junior team members.

To maintain continuity, the Marketing Manager's involvement period overlaps with the Zone Rep's. That happens with a Confirming Phone Call (“CPC”). The Confirming Phone Call is made by the Marketing Manager soon after a Zone Rep schedules a listing appointment with a seller. The CPC not only introduces, in advance, the Marketing Manager to the seller, but demonstrates to the seller the speed and keen interest taken in providing fast, efficient service to the seller.

In that call, the Marketing Manager briefly explains the “process” to the seller and why we can sell homes for such a substantial discount and maintain profitability. People in general have the suspicion that “you get what you pay for,” and so part of the process of the present invention is to deal with that before the Zone Rep arrives.

The next call the Marketing Manager makes to the seller is a congratulatory call within 60 minutes of the Zone Rep signing the listing agreement with the seller. In this call, the Marketing Manager outlines the several steps that will be taken in the next 24 hours as their home sales moves through our process.

The Marketing Manager is the primary quality control person in the process, and the person who confirms the data and marketing information already gathered by the Zone Rep. Further, because no two home sales are exactly alike, the Marketing Manager will consult with the seller by telephone to develop a “customized” marketing plan with the seller. In that marketing discussion with the seller, the Marketing Manager may offer optional “Buyer Finder Network” program, as well as other specialized programs. The Buyer Finder program is, for example, a way for the seller to save a portion of the buyer-side commission. In cases where buyers are not yet represented by an agent, the seller is offered the option to show their own home. Should a successful sale happen as part of the Buyer Finder Network, the seller saves about half of the usual 3% co-agent buyer-side commission. This not only provides a unique savings to the seller, but also represents an additional revenue stream to the brokerage company.

The Marketing Manager, in combination with Buyer Central (discussed below), is the primary contact with the seller until an offer is tendered on the property. Once an offer is tendered, the Designated Broker (discussed below) gets involved.

### Step 3: Buyer Central (a Licensed Call Center)

A licensed call center, referred to as Buyer Central, handles all inbound inquiries resulting from yard signs, internet ads, and other marketing or referral sources. Inquiries typically happen by telephone, email, or text message. The importance of the Buyer Central call center is to maximize the buyer capture rate when buyers inquire about listed properties. Buyers are a unique and valuable income stream to Applicant's business method. The Call Center earns referral fees paid by buyers' agents who accept referrals originating through the Buyer Central call center.

Besides being a better and more professional method of handling in-bound calls, the Applicant attracts and impresses buyers with proprietary programs including “See it in 30™” and “Buyer Showing Team™”.

Buyers' agents who join the Buyer Showing Team (“BST”) network pay referral fees in exchange for buyer leads. BST members take rotational duty in their respective area and are prepared to arrive at a property within 30 minutes of the interested party's initial phone call. This “get there first” approach “locks in” buyer loyalty, which in turn increases the chances that the buyer will continue working with our BST and ultimately earn a referral fee paid from the commission earned from that buyer-side transaction.

Also important is that the Buyer Central call center collects a referral fee whether the buyer purchases one of the company's listings or one listed by another brokerage firm.

### Step 4: Contract & Escrow Specialist (Designated Broker)

The Designated Broker (“DB”) is the highest ranking participant in the process. Aside from administrative and regulatory oversight of the activities of the office, the broker receives all tendered offers on office listings. The DB reviews each offer, prepares a pre-formatted analysis sheet for the seller, then forwards a copy to the Seller.

Once the offer is price-agreed between buyer and seller, the DB will handle the closing paperwork, escrows, inspections, and various other customary closing activities. This is a significant advantage over traditional home selling processes in that, now, all pre-closing details are addressed and handled by an experienced person who is constantly available to address any situation that arises during the escrow period.

The DB utilizes specialized Transaction Management Software which not only streamlines paperwork and improves quality control; its risk-reducing aspect helps cut costs on errors and omissions insurance.

The DB's role is in stark contrast to the traditional real estate selling model where this phase of the selling process is handled by the listing agent. The advantage is that, oftentimes listing agents work outside the office dealing with listings or working with other buyers and can easily become the bottleneck and/or weak in the workflow. By having an experienced DB focus on this important last step in the home selling/buying process, the likelihood that any mistakes will be made to jeopardize the sale is greatly reduced.

This specialization ensures that Applicant's real estate process remains cost effective to the traditional real estate brokerage services now in use. This specialization approach enables Applicant the ability to provide a home seller higher-quality, higher caliber services at a significantly lower cost.

### Step-5: EvaluRank™ Referral Network

What if a client's home doesn't sell?

If the sale of the seller's home is not proceeding fast enough to suit the seller, or, for some reason the seller grows tired of the process, Applicant will assist the seller in hiring a traditional broker or agent.

The Marketing Manager who monitors the progress of the listing and maintains contact with the seller will offer the homeowner the opportunity to cancel the listing and switch to another agent.

This is done through Applicant's EvaluRank™ network. This network tracks and monitors the performance of every agent in the market area.

The seller is provided the names of 3 Top agents. To be a member of the EvaluRank™ Network an agent must have a proven track record in home sales, a willingness to work with the seller at a competitive commission rate, and credit the seller (at closing) the initial prepaid listing fee paid to Applicant by the Seller as prepaid commission.

If the homeowner now wishes to work with a selected agent, the agent will take over the responsibility for open houses and other showings of the property.

The EvaluRank agent pays a referral fee to Applicant for the listing after subtracting the portion rebated to the seller. Exhibit H is an example of a brochure of how the EvaluRank™ Network works.

Finally, the following chart provides a comparison of Applicant's method and the way traditional and discounted or flat fee brokers operate.

COMPARISON OF SERVICES
The following matrix provides a comparison of Applicant's
method to traditional and Discount Brokers.

| Services | Applicant | Traditional | Discount /Flat fee |
|---|---|---|---|
| Data | 4-way control: Zone | Often broker will check | Largely handled by |
| Verification | Rep, Marketing | | seller |
| | Manager, Designated | | |
| | Broker, Seller | | |
| Pricing Strategy | Magic Price Points- | Listing agent provides | Listing agent may |
| | Home pricing | CMA (comps) & price | provide a CMA, or |
| | strategy | opinion | seller establishes |
| | | | their asking price. |
| | | | Some firms charge |
| | | | for an appraisal |
| Listing on internet with | MLS and popular | MLS and popular | MLS-and often an |
| pictures | websites open to public | websites open to public | extra fee for limited |
| | | | additional websites |
| Lockbox | Standard Realtor | Standard Realtor | Various Lockboxes |
| | Lockbox provided | Lockbox | available for rental + |
| | with fully refundable | | deposit |
| | deposit (un-cashed | | |
| | separate check) | | |
| Yard Sign & Call Center | Live response 84 | Varies, by agent. | Varies from no |
| | hours per week; 30- | Sometimes calls are | service to listing |
| | minute showing | taken live, or go to | agent may show |
| | service using a | voicemail, or | home |
| | network of agents | receptionist who takes a | |
| | who are “on-call” | message. Showings | |
| | | handled per responding | |
| | | agent's schedule | |
| Realtor Showings | Realtors book | Showing Service or in- | Agent typically must |
| | showings using fast, | house scheduling | call seller directly |
| | easy online system, | | |
| | or call center handles | | |
| | when necessary | | |
| Realtor Feedback | Provided via | Reluctantly provided in | Add-on services |
| | automated system | most cases | where available |
| Buyer Finder program | Originator-gives the | Listing company offers | Not available |
| | seller a commission | no commission | |
| | saving on buyers | incentive to seller to | |
| | | participate by showing | |
| | | own home. | |
| Open House | Applicant trains seller | Typically two hours and | Add-on services |
| | on how to conduct | considerably less | where available |
| | open house with call | effective than CDR | |
| | center support | model | |
| Changes to Listing | Initiated by seller in | Pricing changes | Varies: some limits |
| | writing; no limits | initiated by listing agent | and fees |
| Contract Paperwork | Designated Broker | Full representation | Varies from minimum |
| Offer Negotiation | handles offer | | service required by |
| | presentation and | | state to full |
| | oversight, taking a | | representation |
| | neutral position | | |
| | during the process | | |
| Contract to Closing | Up-streamed to | Handled by agent or | Variable |
| | experienced, ‘stay-in- | down-streamed to | |
| | office’ broker | assistant | |

Applicant has created a retail business model where the business:
Gets paid when it takes in inventory (prepaid fees for listed homes)
Gets paid when the inventory sits on the shelf (buyer traffic creates referral income)
Gets paid when the inventory sells (closing fees)
Gets paid if inventory doesn't sell (EvaluRank Network referral fees)
Gets exposure to the public from each aspect of its business
Is benevolent to the consumer, charging low flat-fee commissions to sellers while providing an improved level of service

In view of the above, it will be seen that the several objects and advantages of the present disclosure have been achieved and other advantageous results have been obtained.

Having thus described the invention, what is claimed and desired to be secured by Letters Patent is:

1. A real estate selling method comprising:
having a prospective seller of a residential property meet with a representative who prepares the information necessary for a real estate listing;
developing a customized marketing plan for the seller for sale of the property;
utilizing a call center to which telephone calls and emails relating to the listing are directed and through which tours of a listed property are arranged; and,
designating a real estate broker to handle all presentations related to the listed property, negotiation of all offers related to the sale of the property to a purchaser, and all matters related the closing of the sale of the property, whereby residential real estate sales are accomplished in a more timely and cost effective manner that provides better service to residential property sellers than is presently available, reduces commissions and fees having to be paid by home sellers, enables real estate agents and brokers to earn higher fees, and substantially increase the profitability of a real estate brokerage business.

2. The method of claim 1 in which the representative with whom the seller initially meets is a zone representative who is a licensed real estate agent.

3. The method of claim 2 in which the zone representative performs the following functions:
developing leads including finding potential home selling or home buyer prospects;
listing presentations;
assisting a seller in establishing a home pricing strategy using a proprietary method; and,
handling paperwork, photography, and initial data entry of new listings into a computer database.

4. The method of claim 2 in which developing a customized marketing plan with the owner includes a marketing manager who performs the following functions:
confirms the data and marketing information already gathered by the zone representative;
consults with the seller to develop the customized marketing plan, development of the plan including utilizing buyer finder network programs and other specialized marketing programs;
serves as the primary contact with the seller until an offer is tendered on the property; and,
provides quality control of the selling process.

5. The method of claim 1 in which telephone and e-mails to the call center are handled by licensed search and scheduling experts who answer questions posed by a prospective purchaser relating to the listing, and set up property tours for prospective buyers.

6. The method of claim 5 in which the search and scheduling experts refer a property tour to an agent of a prospective purchaser's agent.

7. The method of claim 6 further including providing a showing service to prospective purchasers of the listed property.

8. The method of claim 1 in which paperwork details handled by the real estate broker includes arranging escrows, inspections of the property, and matters related to the closing of the sale of the property.

9. The method of claim 1 further including using a home pricing system to set an initial asking price for the property.

10. The method of claim 9 in which the seller selects a price that matches a value that would be at the top or bottom of a typical purchaser's search range thereby establishing a price point that spans two groups of buyers instead of one.

11. The method of claim 10 in which the price point is expressed in an even thousand dollar amount and is not rounded down, the use of even thousand dollar price points causing the price to overlap into two categories of home prices at which prospective purchasers look, those looking to pay the price amount or less, and those looking to pay the price point amount or more, so that the home may be seen by two sets of potential purchasers rather than just one set.
